(19) United States
(12) Patent Application Publication
(10) Pub. No.: US 2012/0115050 A1
(43) Pub. Date: May 10, 2012

(54) METHOD FOR IN-SITU PREPARATION OF POLYBENZIMIDAZOLE-BASED ELECTROLYTE MEMBRANE AND POLYBENZIMIDAZOLE-BASED ELECTROLYTE MEMBRANE PREPARED THEREBY

(75) Inventors: Hyoung-Juhn Kim, Suwon-si (KR); Byoung Gak Kim, Seoul (KR); Hye Jin Lee, Seoul (KR); Jong Hyun Jang, Yongin-si (KR); Eun Ae Cho, Seoul (KR); Jong Hee Han, Seoul (KR); Suk Woo Nam, Seoul (KR); Seong Ahn Hong, Seoul (KR); Tae Hoon Lim, Seoul (KR)

(73) Assignee: Korea Institute of Science & Technology, Seoul (KR)

(21) Appl. No.: 13/240,318

(22) Filed: Sep. 22, 2011

(30) Foreign Application Priority Data
Nov. 4, 2010 (KR) 10-2010-0109421

(51) Int. Cl. H01M 8/10; H01M 8/00

(52) U.S. Cl. 429/408; 429/492; 429/493

(57) ABSTRACT

Disclosed is a method for in-situ preparation of a polybenzimidazole-based electrolyte membrane, including: polymerizing a polybenzimidazole polymer in a solution; casting a solution containing the polymerized polymer onto a substrate and drying the solution in air to form a membrane; washing the dried membrane with water or alcohol; and allowing water or alcohol to evaporate from the membrane containing water or alcohol, while maintaining the shape of the membrane. The method for in-situ preparation of a polybenzimidazole-based electrolyte membrane allows easy preparation of a polybenzimidazole-based electrolyte membrane having a desired area without any complicated processes, and thus contributes to simplification of an overall process for fabricating a fuel cell.

### CROSS-REFERENCE TO RELATED APPLICATION

This application claims priority to Korean Patent Application No. 10-2010-0109421, filed on 4 Nov., 2010, and all the benefits accruing therefrom under 35 U.S.C. §119, the contents of which in its entirety are herein incorporated by reference.

### BACKGROUND

1. Field

The present disclosure relates to a method for in-situ preparation of a polybenzimidazole-based electrolyte membrane and a polybenzimidazole-based electrolyte membrane prepared thereby.

2. Description of the Related Art

Polymer electrolyte fuel cells (PEFCs) are one of eco-friendly future energy sources applicable to portable systems, automobiles and electric power generating systems.

Polymer electrolyte membranes that have been used hitherto in polymer electrolyte fuel cells include perfluorosulfonic acid polymer membranes, i.e. Nafion®, available from DuPont Co. However, Nafion membranes are expensive and thus have low industrial applicability, show high methanol permeabilization, and undergo a drop in efficiency as polymer membranes at 80° C. or higher. Therefore, many studies have been conducted to develop electrolyte membranes using non-fluoropolymers, such as hydrocarbon-based polymers.

Polybenzimidazole-based polymers doped with inorganic acids, such as strong acids, may be used in polymer electrolyte fuel cells, particularly in high-temperature type polymer electrolyte fuel cells.

Polybenzimidazole-based polymers, such as poly[2,2′-(m-phenylene)-5,5′-bibenzimidazole] (polybenzimidazole, PBI) or poly(2,5-benzimidazole) (ABPBI), are heterocyclic polymers, cheap and thermally and chemically stable under various types of environment. In addition, such polymers have a strong structure in their backbone chains and show a high glass transition temperature (Tg).

The known polybenzimidazole-based polymers may be converted into membranes by polymerizing such polymers in the form of solution, providing the polybenzimidazole-based polymers as powder or fibers, and dissolving and precipitating the powder or fibers in organic solvents (e.g.: NMP, DMAc).

### SUMMARY

When the known polybenzimidazole-based polymers are converted into membranes, the polybenzimidazole-based polymers show poor solubility in carrying out precipitation in an organic solvent after preparing the polybenzimidazole-based polymers. Thus, complicated additional processes, such as adding lithium bromide (LiBr) or increasing temperature, are required to solve the above-mentioned problem.

The present disclosure is directed to providing a method for in-situ preparation of a polybenzimidazole-based electrolyte membrane, which allows formation of a membrane while avoiding a need for precipitating a polybenzimidazole derivative after the polymerization thereof, includes fixing the formed membrane at its end portions to allow the membrane to maintain the shape, and thus facilitates formation of a membrane without any complicated processes. The present disclosure is also directed to providing a polybenzimidazole-based electrolyte membrane prepared by the same method.

In one aspect, there is provided a method for in-situ preparation of a polybenzimidazole-based electrolyte membrane, including:

polymerizing a polybenzimidazole polymer in a solution;

casting a solution containing the polymerized polymer onto a substrate and drying the solution in air to form a membrane;

washing the dried membrane with water or alcohol; and

allowing water or alcohol to evaporate from the membrane containing water or alcohol, while maintaining the shape of the membrane.

According to an embodiment, there is no particular limitation of the viscosity or temperature of the solution subjected to casting, as long as the solution is cast suitably onto the substrate and maintains its shape without flowing so that it is converted into a membrane. However, since the solution is subjected to casting directly after the polymerization, it may have any range of temperatures lower than the polymerization temperature (220° C. in the case of poly[2,2′-(m-phenylene)-5,5′-bibenzimidazole] (PBI) or 160° C. in the case of poly(2,5-benzimidazole) (ABPBI)). In addition, the concentration and temperature of the casting solution is directly related with the viscosity. A solution with lower viscosity may be subjected to lower casting temperature. In this manner, it is possible to control the solution with ease to a desired level of viscosity.

According to another embodiment, maintaining the shape of the membrane is carried out by fixing the end portions, specifically the end portions of the membrane at four directions with a plurality of tongs.

In another aspect, there is provided a polybenzimidazole-based electrolyte membrane prepared by the above-described method.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic flow chart illustrating the method for in-situ preparation of a polybenzimidazole-based polymer electrolyte membrane in accordance with an exemplary embodiment;

FIG. 2a is a schematic view illustrating washing a polybenzimidazole-based polymer electrolyte membrane with water or alcohol in accordance with an exemplary embodiment; and

FIG. 2b is a schematic view illustrating fixing a polybenzimidazole-based polymer electrolyte membrane in accordance with an exemplary embodiment.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

According to some embodiments of the method disclosed herein, formation of a membrane is carried out simultaneously with the completion of polymerization, the membrane is dried and allowed to be in contact with water or alcohol to remove the doped acid, and then water or alcohol is allowed to evaporate from the membrane containing water or alcohol while the shape of the membrane is maintained. In this manner, the method disclosed herein facilitates preparation of a polybenzimidazole-based polymer membrane having a desired area, as compared to the known solution polymerization processes including polymerizing a polymer, for example, in the form of powder, and precipitating the polymer in a poor solvent to obtain a polymer.

In an exemplary embodiment, the method for in-situ preparation of a polybenzimidazole-based electrolyte membrane, includes:

polymerizing a polybenzimidazole polymer in a solution (S1);

casting a solution containing the polymerized polymer onto a substrate and drying the solution in air to form a membrane (S2);

washing the dried membrane with water or alcohol (S3); and

allowing water or alcohol to evaporate from the membrane containing water or alcohol, while maintaining the shape of the membrane (S4).

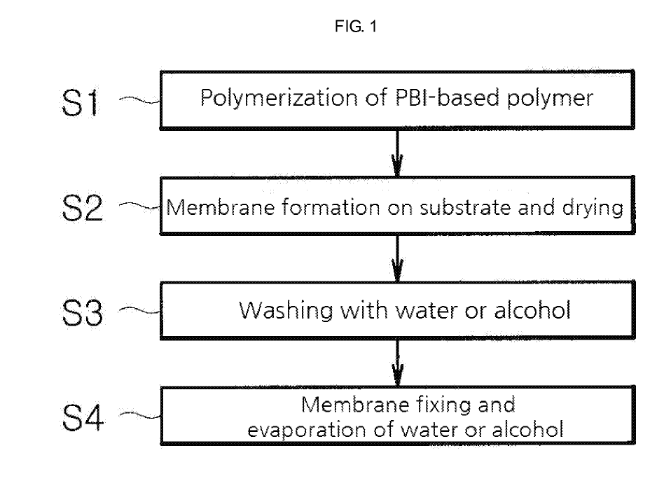

FIG. 1 is a schematic flow chart illustrating the method for in-situ preparation of a polybenzimidazole-based polymer electrolyte membrane in accordance with an exemplary embodiment.

As shown in FIG. 1, first, a polybenzimidazole-based polymer is polymerized (S1).

There is no particular limitation in polybenzimidazole-based polymer obtained from the method disclosed herein and non-limiting examples thereof include the polybenzimidazole-based polymers represented by the following Chemical Formulae 1-8:

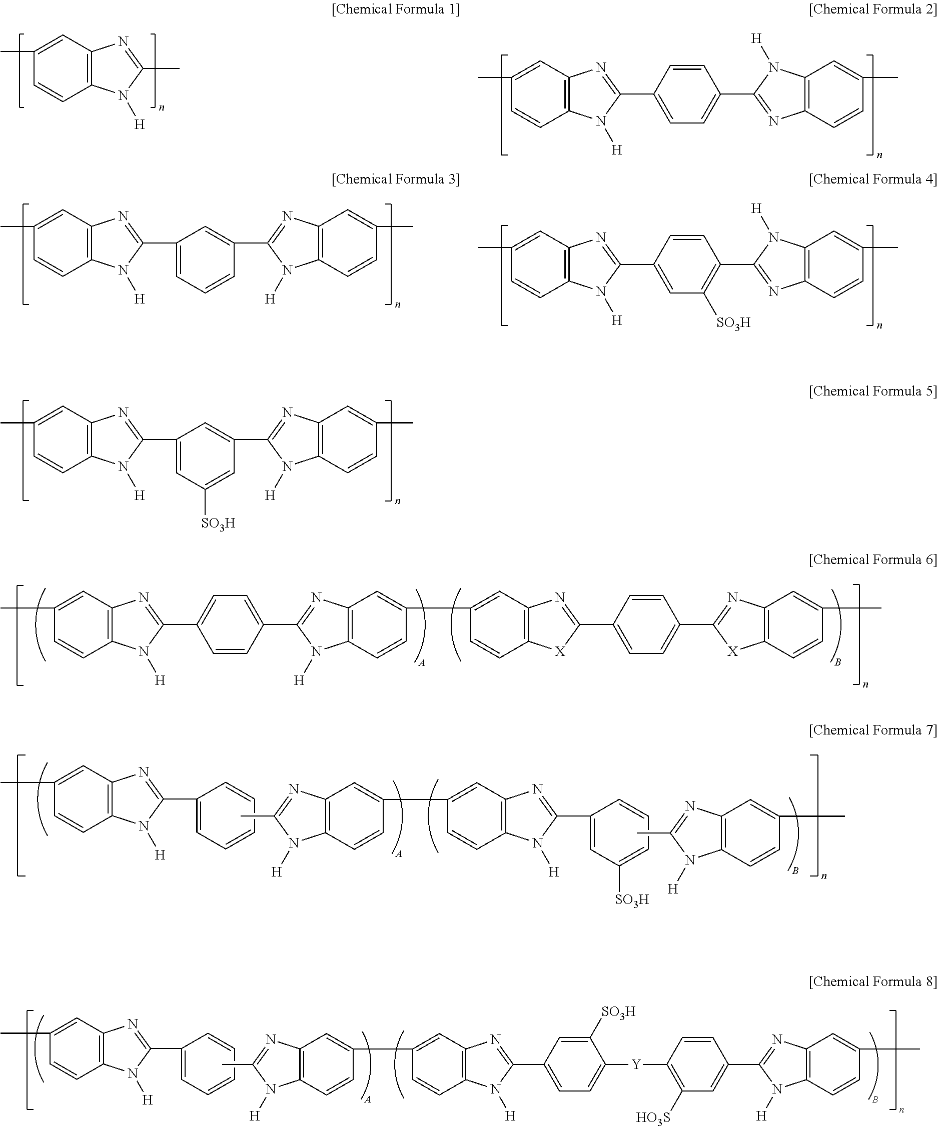

In Chemical Formulae 6-8, A and B represent percentages of repeating units not containing sulfonic acid groups and those of repeating units containing sulfonic acid groups, respectively, wherein A is 0-99 and B is 100-1. In Chemical Formula 8, Y is nil or, if present, Y is O or S.

In a non-limiting exemplary embodiment, a typical polybenzimidazole-based polymer, polybenzimidazole, is polymerized from 3,3′-diaminobenzidine, isophthalic acid and polyphosphoric acid under inert atmosphere.

When carrying out polymerization using a solvent, a solution containing a polymer dissolved homogeneously in a solvent is controlled in terms of its viscosity and temperature.

Such control of the viscosity and temperature of the solution facilitates formation of a membrane directly on a substrate, while avoiding a need for precipitating the polymer in a poor solvent.

Once the polymerization is completed and the solution undergoes a color change, the resultant polybenzimidazole-based polymer solution is subjected to casting on a substrate (S2).

After the resultant cast membrane is stored in air, for example, at 25° C. under a relative humidity of 40±5% for about one day, polyphosphoric acid in the polybenzimidazole-based membrane is converted into phosphoric acid by moisture in the air, thereby providing an acid-doped polybenzimidazole-based polymer membrane.

Then, the acid-doped polybenzimidazole-based polymer membrane is dipped into water or alcohol (e.g. methanol) or washed with water or alcohol to remove phospshoric acid (S3).

Since the polybenzimidazole-based polymer membrane, from which phosphoric acid is washed out, still contains a large amount of water or alcohol, it is required to remove water or alcohol. While removing water or alcohol, the membrane is fixed at its end portions to prevent the membrane from being deformed (S4).

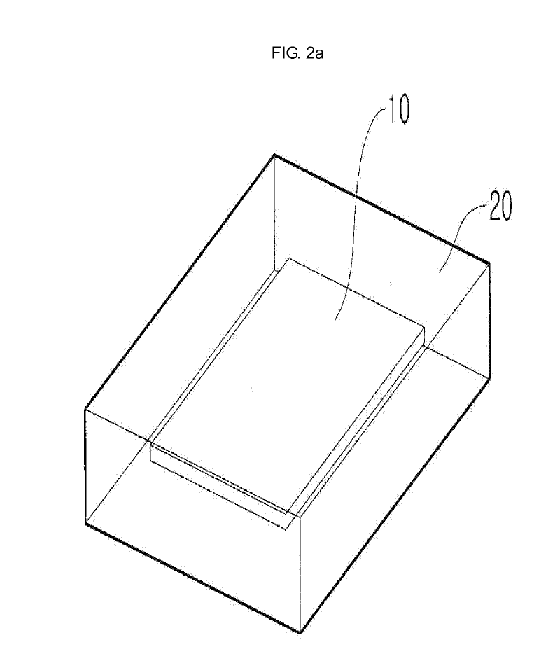

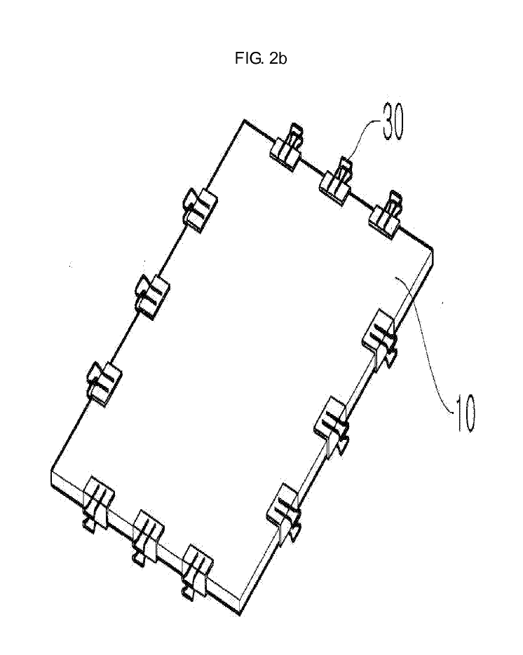

FIG. 2a is a schematic view illustrating washing a polybenzimidazole-based polymer electrolyte membrane with water or alcohol in accordance with an exemplary embodiment, and FIG. 2b is a schematic view illustrating fixing a polybenzimidazole-based polymer electrolyte membrane in accordance with an exemplary embodiment.

As shown in FIG. 2, the polybenzimidazole-based polymer membrane 10 doped with phosphoric acid is dipped into water or alcohol 20 to wash phosphoric acid. Then, water or alcohol is allowed to evaporate from the membrane 10 while fixing the end portions of the membrane with tongs 30. In this manner, it is possible to prevent the membrane from shrinking. Such operation of fixing the membrane is more efficient than the known method including membrane casting after precipitation, and allows the resultant membrane to have an area equal to or greater than the area obtained from the known membrane casting process.

Although tong-shaped parts for fixing four sides of the membrane are shown in FIG. 2, fixing parts that may be used herein are not limited thereto and any fixing parts may be used as long as they are capable of maintaining the membrane shape.

The electrolyte membrane using a polybenzimidazole-based polymer obtained as described above is useful for fuel cells, particularly for polymer electrolyte fuel cells.

### EXAMPLES

The examples will now be described. The following examples are for illustrative purposes only and not intended to limit the scope of the present disclosure. In the following examples, representative polybenzimidazoles, i.e., poly[2,2′-(m-phenylene)-5,5′-bibenzimidazole] (PBI) and poly(2,5-benzimidazole) (ABPBI) are prepared and membranes are obtained therefrom.

### Example

### Preparation of PBI and Formation of Membrane

In a 1 L two-neck round-bottom flask, 3,3′-diaminobenzidine (12 g), isophthalic acid (9.3 g) are introduced into polyphosphoric acid. The reaction mixture is heated to 220° C. under nitrogen atmosphere and polymerization is carried out for 25 hours. The reaction mixture is stirred by using a mechanical overhead stirrer. The stirring rate is set 100 rpm at room temperature. Once stirring is initiated, polyphosphoric acid undergoes a drop in viscosity as the temperature increases. Thus, the stirring rate is increased to 300 rpm. As the reaction further proceeds, the reaction solution undergoes an increase in viscosity, and thus the stirring rate is decreased finally to 180-200 rpm.

While the reaction proceeds, the solution undergoes a change in color from a red brown color to a dark brown color. The resultant PBI solution is poured onto a clean glass plate and membrane casting is carried out by using a doctor blade.

After the cast PBI membrane is stored at 25° C. under a relative humidity of 40±5% for about one day, polyphosphoric acid in the PBI membrane is converted into phosphoric acid by moisture in the air. As a result, a PBI membrane having an acid doping level of about 20-30 (mol H₃PO₄/mol PBI units) is formed.

The resultant PBI membrane has a thickness of 200-600 μm. The membrane is dipped into water to remove phosphoric acid totally, and washed with water several times to remove residual phosphoric acid completely.

Since the membrane obtained as described above still contains a large amount of water, it is positioned on a solid body, such as a clean glass plate, and the end portions at four sides of the membrane are fixed with tongs (see FIG. 2b). Such fixing allows the membrane to maintain its shape even after water evaporation. As a result, it is possible to obtain a large-area membrane with ease.

In this example, water is used to remove phosphoric acid. However, use of alcohol for this purpose allows more rapid formation of a membrane. It is a matter of course that the membrane is fixed to maintain its shape when using alcohol.

Preparation of ABPBI and Formation of Membrane

First, 3,4-diaminobenzoic acid (4 g, 26.3 mmol) is combined with a mixture of P₂O₅ (8 g) and CH₃SO₃H (40 mL) and a reaction is carried out at 160° C. for 1 hour. The resultant polymer solution is applied uniformly onto a glass plate by using a doctor blade, and the glass plate coated with the polymer solution is dipped into water to detach the membrane from the glass plate, thereby providing an ABPBI membrane. Similarly to the preparation of PBI, the resultant ABPBI membrane is dipped into water to remove the solvent completely. The membrane still containing a large amount of water is fixed on a glass plate to perform water evaporation while maintaining the shape of the membrane by using tongs. In this manner, it is possible to obtain an ABPBI membrane with ease.

Also in this case, use of alcohol allows more rapid formation of a membrane. It is a matter of course that the membrane is fixed to maintain its shape during the alcohol evaporation.

### Comparative Example

In a 1 L two-neck round-bottom flask, 3,3′-diaminobenzidine (12 g) and isophthalic acid (9.3 g) are introduced into polyphosphoric acid. The reaction mixture is polymerized at 220° C. under nitrogen atmosphere for 25 hours. The reaction mixture is stirred by using a mechanical overhead stirrer. The stirring rate is set 100 rpm at room temperature. Once stirring is initiated, polyphosphoric acid undergoes a drop in viscosity as the temperature increases. Thus, the stirring rate is increased to 300 rpm. As the reaction further proceeds, the reaction solution undergoes an increase in viscosity, and thus the stirring rate is decreased finally to 180-200 rpm. While the reaction proceeds, the solution undergoes a change in color from a red brown color to a dark brown color.

The resultant solution is subjected to precipitation in water to obtain a polymer. The polymer is dried in a vacuum oven at 100° C. for 24 hours to obtain PBI powder having an intrinsic viscosity of about 1.5-3.0 dL/g. The resultant PBI (5 g) is dissolved into DMAc (100 mL) and an adequate amount of solution is poured onto a glass plate. Then, membrane casting is carried out by using a doctor blade. The cast membrane is dried in a vacuum oven at 60° C. for 50 hours to obtain a PBI membrane. The resultant membrane is dipped into 60% phosphoric acid for 3 days to obtain a polymer electrolyte membrane having a doping level of 400%.

The method for in-situ preparation of a polybenzimidazole-based electrolyte membrane disclosed herein allows easy preparation of a polybenzimidazole-based electrolyte membrane having a desired area without any complicated processes, and thus contributes to simplification of an overall process for fabricating a fuel cell.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A method for in-situ preparation of a polybenzimidazole-based electrolyte membrane, comprising:
polymerizing a polybenzimidazole polymer in a solution;
casting a solution containing the polymerized polymer onto a substrate and drying the solution in air to form a membrane;
washing the dried membrane with water or alcohol; and
allowing water or alcohol to evaporate from the membrane containing water or alcohol, while maintaining the shape of the membrane.

2. The method for in-situ preparation of a polybenzimidazole-based electrolyte membrane according to claim 1, wherein the membrane is fixed at the end portions thereof with a plurality of tongs to maintain the shape of the membrane.

3. The method for in-situ preparation of a polybenzimidazole-based electrolyte membrane according to claim 2, wherein the end portions of the membrane are fixed at four directions thereof.

4. The method for in-situ preparation of a polybenzimidazole-based electrolyte membrane according to claim 1, wherein the polybenzimidazole-based polymer is at least one selected from the polybenzimidazole-based polymers represented by the following Chemical Formulae 1-8: 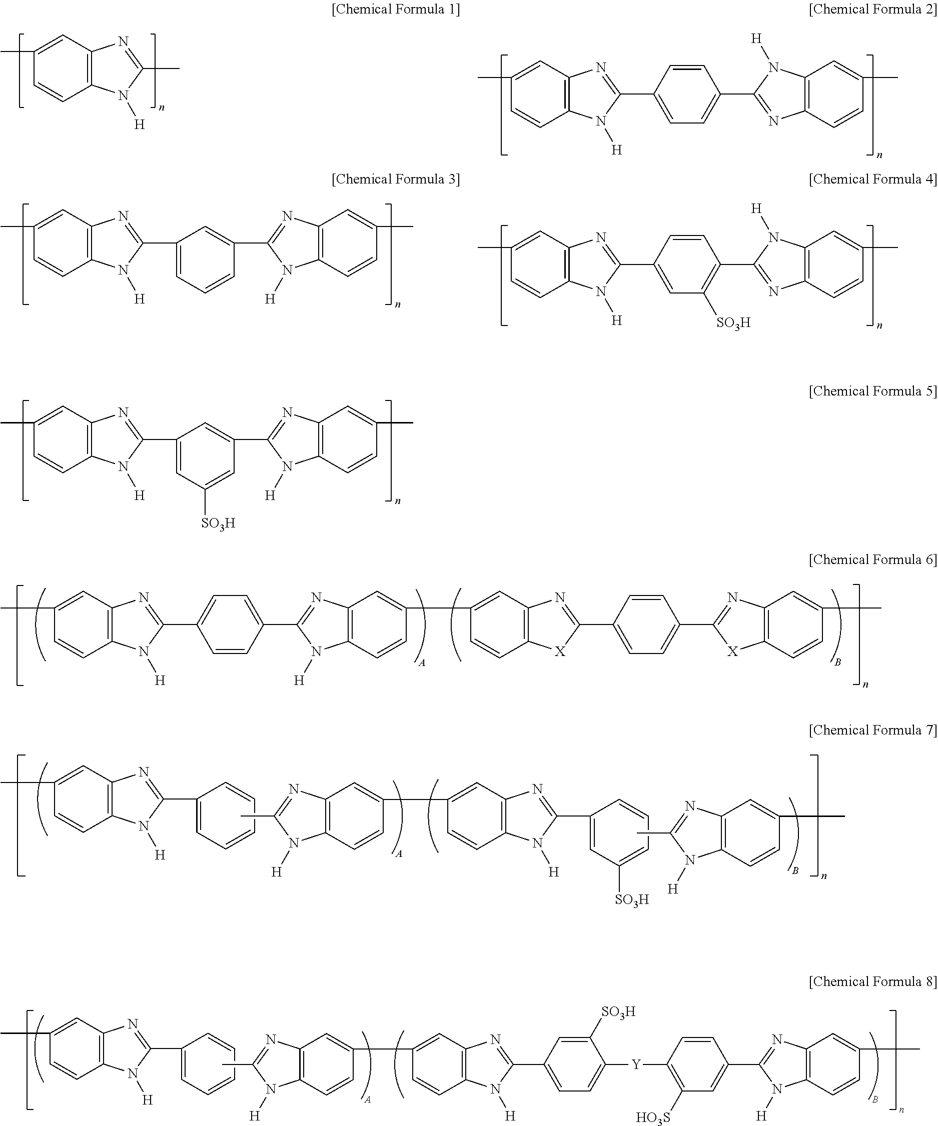
In Chemical Formulae 6-8, A and B represent percentages of repeating units not containing sulfonic acid groups and those of repeating units containing sulfonic acid groups, respectively, wherein A is 0-99 and B is 100-1. In Chemical Formula 8, Y is nil or, if present, Y is O or S.

5. A polybenzimidazole-based electrolyte membrane prepared by the method as defined in claim 1.

6. A polybenzimidazole-based electrolyte membrane prepared by the method as defined in claim 2.

7. A polybenzimidazole-based electrolyte membrane prepared by the method as defined in claim 3.

8. A polybenzimidazole-based electrolyte membrane prepared by the method as defined in claim 4.
